(19) United States
(12) Patent Application Publication
(10) Pub. No.: US 2010/0014825 A1
(43) Pub. Date: Jan. 21, 2010

(54) USE OF A SECONDARY DEVICE TO OVERLAY DISASSOCIATED MEDIA ELEMENTS ONTO VIDEO CONTENT

(75) Inventors: Scott Curtis, Durham, NC (US); Alfredo C. Issa, Apex, NC (US); Michael W. Helpingstine, Chapel Hill, NC (US)

Correspondence Address: WITHROW & TERRANOVA CT, 100 REGENCY FOREST DRIVE , SUITE 160, CARY, NC, 27518, US

(73) Assignee: PORTO TECHNOLOGY, LLC, WILMINGTON, DE (US)

(21) Appl. No.: 12/175,733

(22) Filed: Jul. 18, 2008

(51) Int. Cl. H04N 5/91

(52) U.S. Cl. 386/46

(57) ABSTRACT

A system and method are provided for utilizing a secondary device to overlay disassociated media elements onto video content presented to a user via a primary device. In general, an overlay control function of a secondary device provides an overlay input to a primary device playing video content. The overlay input includes one or more media elements forming the overlay as well as information defining a desired position of the overlay. In response, an overlay rights enforcement function of the primary device obtains overlay access rights and determines whether the overlay is permitted based on overlay access rights. If the overlay is permitted, the overlay formed by the one or more media elements provided in the overlay input received from the secondary device is overlaid on top of the video content being played by the primary device.

### FIELD OF THE INVENTION

The present invention relates to overlaying media elements onto video content.

### BACKGROUND OF THE INVENTION

Current models for interactive television tend to require that all elements of the viewing experience be integrated through a single, sanctioned and “official” source. For example, in traditional digital or satellite television models, the user's set top box is used to aggregate broadcast and interactive elements. Accordingly, an opportunity exists for a much more open and adaptable model for interactive television.

### SUMMARY OF THE INVENTION

The present invention relates to the use of a secondary device to overlay disassociated media elements onto video content presented to a user via a primary device. In general, an overlay control function of a secondary device provides an overlay input to a primary device playing video content. The overlay input includes one or more media elements forming the overlay as well as information defining a desired position of the overlay. In response, an overlay rights enforcement function of the primary device obtains overlay access rights and determines whether the overlay is permitted based on overlay access rights. In one embodiment, the overlay access rights generally define times at which the overlay may be presented, times at which the overlay may not be presented, positions at which the overlay may be presented, positions at which the overlay is not permitted, or any combination thereof. If the overlay is permitted, the overlay formed by the one or more media elements provided in the overlay input received from the secondary device is overlaid on top of the video content being played by the primary device.

In one embodiment, the overlay is inserted into the video content being played by the primary device and the resulting video content including the overlay is presented to the user via an associated display device. The associated display device may be an external display device or an internal display device of the primary device. In another embodiment, the video content being played by the primary device is presented to the user via a primary display, and the overlay is presented to the user via a secondary display positioned on top of or in front of the primary display. Each of the primary display and secondary display may be an internal display of the primary device or external display device.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system utilizing a secondary device to present an overlay on video content being played by a primary device according to one embodiment of the present invention;

FIG. 2 illustrates the operation of the system of FIG. 1 according to one embodiment of the present invention;

FIG. 3 illustrates the operation of the overlay rights enforcement function and video playback function of the primary device of FIG. 1 according to one embodiment of the present invention;

FIG. 4 illustrates the operation of the overlay rights enforcement function and video playback function of the primary device of FIG. 1 according to another embodiment of the present invention;

FIGS. 5A through 5C illustrate an exemplary overlay provided by the secondary device of FIG. 1 according to one embodiment of the present invention;

FIGS. 6A and 6B illustrate another exemplary overlay provided by the secondary device of FIG. 1 according to one embodiment of the present invention;

FIG. 7 is a block diagram of the primary device of FIG. 1 according to one embodiment of the present invention; and

FIG. 8 is a block diagram of the secondary device of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

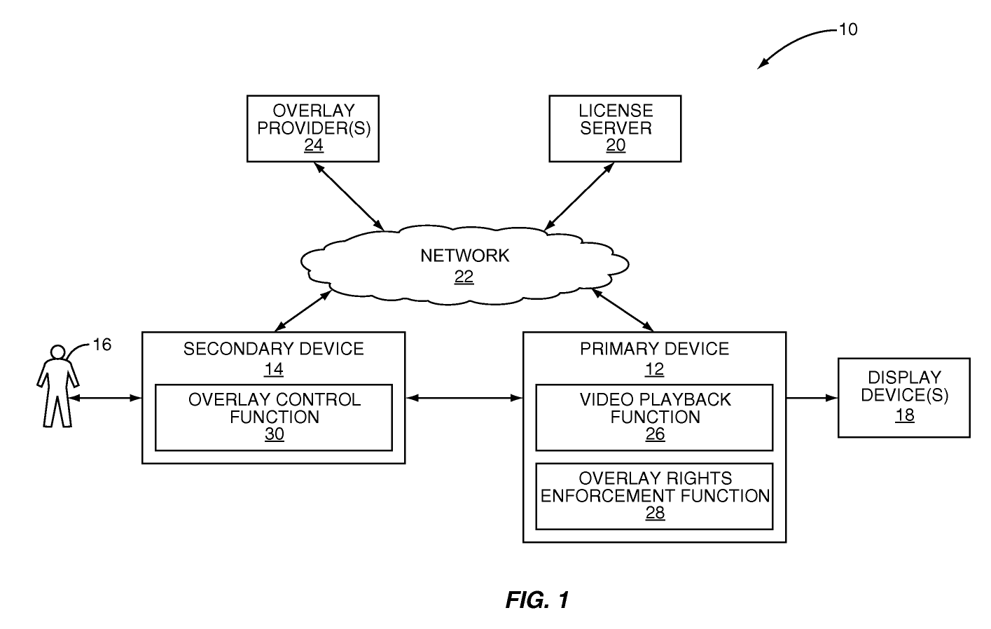

FIG. 1 illustrates a system 10 enabling presentation of an overlay onto video content presented to a user according to one embodiment of the present invention. In general, the system 10 includes a primary device 12 and a secondary device 14 having an associated user 16. The secondary device 14 is enabled to connect to the primary device 12 via a local connection. The local connection may be a wired local connection such as a Universal Serial Bus (USB) connection, an IEEE 1394 or Firewire® connection, or the like. Alternatively, the local connection may be a local wireless connection such as a Bluetooth® connection, an IEEE 802.11x connection, or the like. In this embodiment, the primary device 12 is connected to one or more display devices 18 via one or more audio/video (A/V) connections such as, for example, one or more Digital Video Interface (DVI) connections, one or more High Definition Multimedia Interface (HDMI) connections, one or more S-Video connections, one or more component video connections, or the like.

In addition, in one embodiment, the primary device 12 may be enabled to connect to a license server 20 via a network 22. The primary device 12 may be connected to the network 22 using any desired wired or wireless connection. Likewise, the secondary device 14 may be enabled to connect to one or more overlay control function providers 24 via the network 22 or a separate network. The secondary device 14 is preferably connected to the network 22 via a wireless connection, which may be a local wireless connection, a mobile telecommunications network connection, or the like. The network 22 may be, for example, a Wide Area Network (WAN) such as the Internet.

The primary device 12 may be, for example, a set-top box such as that provided by a cable or satellite television service provider, a personal computer having video playback capabilities, a gaming console having video playback capabilities, a Digital Video Disc (DVD) player, a Blu-ray disc player, a video playback console such as an Apple TV® device, or the like. Note that while in this embodiment the one or more display devices 18 are external from the primary device 12, the present invention is not limited thereto. In an alternative embodiment, the primary device 12 and the one or more display devices 18 may be an integrated device.

The primary device 12 includes a video playback function 26 and an overlay rights enforcement function 28, each of which may be implemented in software, hardware, or a combination thereof. The video playback function 26 generally operates to provide playback of video content. The video content may be video content delivered from a remote source such as a cable television headend, a streaming media server such as a server providing streaming video via an Internet Protocol (IP) network, or the like. The video content may alternatively be local video content such as video content previously downloaded from a remote source such as an e-commerce service, video content stored on a DVD, Blu-ray disc, or similar removable digital storage medium, or the like. In addition, in one embodiment, the video playback function 26 also operates to insert an overlay from the secondary device 14 onto video content being played by the primary device upon approval by the overlay rights enforcement function 28, as discussed below.

The overlay rights enforcement function 28 generally operates to enforce overlay access rights restricting times at which overlays from the secondary device 14 are permitted, positions within frames of the video content being played by the primary device 12 at which overlays are permitted, or both. The access rights are preferably associated with defined video content such as, for example, one or more defined video items such as one or more movies or one or more television programs; video content broadcast via a defined television station or television channel; or the like. In one embodiment, the access rights are overlay-specific access rights defined by a license obtained from the license server 20. In addition to the overlay-specific access rights, default access rights may be defined for overlays generated by overlay control functions, such as the overlay control function 30 of the secondary device 14, that are not known or registered to the system 10. In other words, in one embodiment, the default overlay access rights may be defined for overlay control functions for which licenses have not been issued via the license server 20. Still further, global access rights may be defined for all overlay control functions whether or not the overlay control functions are registered with the system 10 by, for example, being issued a license via the license server 20. In another embodiment, rather than having overlay-specific access rights and, optionally, default and/or global overlay access rights, overlay access rights defined for video content may be applicable to all overlay control functions including the overlay control function 30.

As stated above, overlay-specific access rights may be obtained from the license server 20. Default access rights and global access rights may be obtained from the license server 20 or provided in association with the video content. For example, for streaming video content, the default access rights and global access rights may be provided as metadata within the streaming video file, metadata multiplexed with the video content onto a single communications channel, or metadata provided via a separate communications channel. Similarly, in the embodiment where overlay access rights are defined for video content and are applicable to all overlay control functions, the overlay access rights may be obtained from the license server 20, provided in association with the video content, or the like.

The secondary device 14 is preferably a mobile device such as a mobile smart phone. For example, the secondary device 14 may be an Apple® iPhone or similar device. However, the present invention is not limited thereto. In general, the secondary device 14 includes an overlay control function 30 which may be implemented in software, hardware, or a combination thereof. In the preferred embodiment, the system 10 includes one or more overlay control function providers 24 which host and make available overlay control functions for various types of overlays. As such, under the control of the user 16, the overlay control function 30 is preferably downloaded from one of the overlay control function providers 24 and installed on the secondary device 14. However, the present invention is not limited thereto. In general, the overlay control function 30 enables the user 16 to configure and control an overlay that is then communicated to the primary device 12 and overlaid onto video content being played by the primary device 12. Thereafter, the overlay control function 30 may update the overlay as needed depending on the particular embodiment of the overlay.

The specific operation of the overlay control function 30 depends on the type of overlay provided thereby. Some exemplary types of overlays are discussed below. However, the present invention is not limited to these examples. Other types of overlays will be apparent to one of ordinary skill in the art upon reading this disclosure and are to be considered within the scope of the present invention. As a first example, the overlay control function 30 may provide a pointer overlay enabling the user 16 to utilize the secondary device 14 to control a pointer overlaid on the video content being played by the primary device 12. As a second example, the overlay control function 30 may provide a telestrator overlay enabling the user 16 to utilize the secondary device 14 as a telestrator for video content being played by the primary device 12. As a third example, the overlay control function 30 may provide a custom sports banner or game tracker overlay providing scores of one or more sporting events of interest to the user 16. As a fourth example, the overlay control function 30 may provide a custom text overlay, such as a custom text scroll or banner, providing, for example, news of interest to the user 16.

As a fifth example, the overlay control function 30 may provide a shopping overlay enabling the user 16 to click on objects appearing in the video content being played by the primary device 12 and, in response, be directed to one or more websites for purchasing the selected object, informed of a best deal for that object, or like. More specifically, the overlay control function 30 may have embedded information or be enabled to obtain information from a remote source identifying objects appearing in video content being played by the primary device 12 and times during playback at which those objects appear. The overlay control function 30 may then determine a playback position in playback of the video content based on the time of day, information obtained from the primary device 12, or the like. Once the playback information is known, the overlay control function 30 may provide the overlay enabling the user 16 to select objects of interest that appear in the video content. In response, the overlay control function 30 directs the user 16 to one or more e-commerce services, such as websites, offering the selected object for purchase by the user 16.

As a sixth example, the overlay control function 30 may provide a game that can be played by the user 16 while viewing the video content being played by the primary device 12. The game is preferably not directly associated with the video content being played. As a seventh example, the overlay control function 30 may provide a picture-in-picture overlay presenting video content being played by the secondary device 14. As an eighth example, the overlay control function 30 may provide an email overlay enabling the user 16 to read emails, compose emails, or the like during playback of the video content. For instance, the overlay control function 30 may enable the user 16 to review, send, and receive email messages via an overlay where the underlying email service may be an application hosted on the secondary device 14, a web-based email service, or the like.

As a ninth example, the overlay control function 30 may provide a related Internet content overlay for presenting Internet content related to the video content being played by the primary device 12. For example, the overlay control function 30 may obtain information identifying the video content being played by the primary device 12 from the primary device 12. Then, the overlay control function 30 may, for example, perform or initiate an Internet search for related content. The overlay control function 30 may then provide the related content resulting from the Internet search, or a portion thereof, as an overlay to be overlaid upon the video content being played by the primary device 12. As a tenth example, the overlay control function 30 may provide a text messaging overlay enabling the user 16 to read and compose text messages during playback of the video content by the primary device 12. The underlying text messaging function may be an application hosted by the secondary device 14, a web-based application, or the like. As a final example, the overlay control function 30 may provide a custom content overlay provided by, for example, a mobile telecommunications service provider of the secondary device 14.

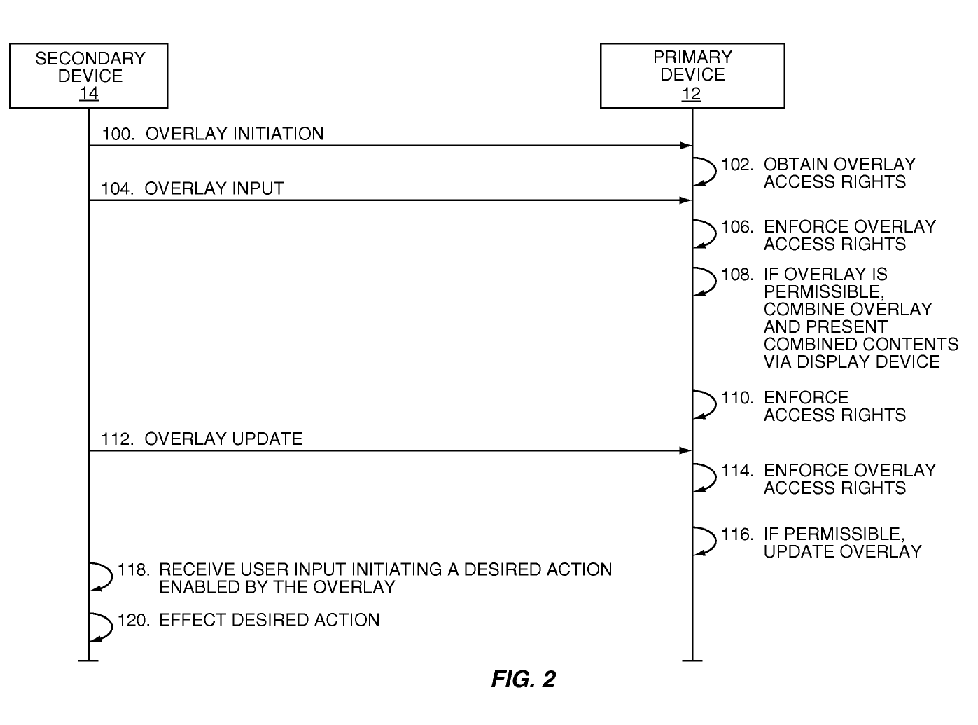

FIG. 2 illustrates the operation of the system 10 of FIG. 1 according to one embodiment of the present invention. First, in this example, the secondary device 14, and more specifically the overlay control function 30, initiates overlay operation (step 100). For example, in one embodiment, the overlay control function 30 may initiate overlay operation by sending a validation request to the primary device 12. In response, the overlay rights enforcement function 28 of the primary device 12 obtains overlay access rights for the video content being played by the primary device 12 (step 102). The overlay access rights may be defined by a provider of the video content such as a television service provider, by a producer or creator of the video content, by a manufacturer of the primary device 12, or the like. The overlay access rights generally define positions at which the overlay provided by the overlay control function 30 of the secondary device 14 may be presented within frames of video content being played by the primary device 12, positions at which the overlay provided by the overlay control function 30 of the secondary device 14 may not be presented within frames of video content being played by the primary device 12, times at which the overlay provided by the overlay control function 30 of the secondary device 14 may be presented during playback of the video content, times at which the overlay provided by the overlay control function 30 of the secondary device 14 may not be presented during playback of the video content, or any combination thereof.

In one embodiment, the overlay rights enforcement function 28 requests a license defining the access rights from the license server 20. More specifically, in one embodiment, the license server 20 stores a number of licenses, where each license defines access rights for defined video content (e.g., a video content item such as a movie or television program, a television station or channel, or the like) for a defined overlay control function. Thus, using an identifier of the overlay control function 30 and an identifier of video content being played by the primary device 12, the overlay rights enforcement function 28 may query the license server 20 to obtain a license defining the overlay access rights granted to the overlay control function 30 for the video content being played by the primary device 12. Note that while licenses are utilized in this exemplary embodiment to define overlay-specific access rights, the present invention is not limited thereto. Numerous alternative schemes for providing overlay-specific access rights will be apparent to one of ordinary skill in the art upon reading this disclosure and are to be considered within the scope of the present invention. For instance, the overlay-specific access rights for the video content may be provided as metadata within the corresponding video content file, as metadata provided via a standard such as the MPEG-7 standard, or the like.

Optionally, if overlay-specific access rights have not been granted to the overlay control function 30, the overlay rights enforcement function 28 may request or the license server 30 may return a license defining default overlay access rights for the video content being played by the primary device 12. Alternatively, the default overlay access rights may be provided in association with the video content. For example, the default overlay access rights may be provided as metadata associated with the video content. As another example, if the video content is a television channel provided by a television service provider, the default overlay access rights and the video content may be multiplexed and provided on the television channel. As one exemplary alternative, the default overlay access rights may be provided by the television service provider via a separate communications channel such as an unused television channel or a separate physical communication link. The default overlay access rights may be defined by a provider of the video content such as a television service provider, by a producer or creator of the video content, by a manufacturer of the primary device 12, or the like.

Still further, in addition to overlay-specific access rights and, optionally, the default overlay access rights, global overlay access rights may be provided and used for all overlay control functions, including the overlay control function 30, regardless of whether overlay-specific access rights have been granted. The global overlay access rights may be provided by the license server or provided in association with the video content being played by the primary device 12. The global overlay access rights may be defined by a provider of the video content such as a television service provider, by a producer or creator of the video content, by a manufacturer of the primary device 12, or the like.

In an alternative embodiment, rather than having overlay-specific access rights and, optionally, default overlay access rights and/or global overlay access rights, overlay access rights may be defined for the video content being played by the primary device 12 and used for all overlay control functions including the overlay control function 30. These access rights may be provided by a license obtained from the license server 20 or may be provided in association with the video content. Again, these overlay access rights may be defined by a provider of the video content such as a television service provider, by a producer or creator of the video content, by a manufacturer of the primary device 12, or the like. For instance, the access rights for the video content may be provided as metadata associated with the video content.

After obtaining the overlay access rights, the primary device 12 receives overlay input from the overlay control function 30 of the secondary device 14 (step 104). In one embodiment, the overlay input includes information defining media elements forming the overlay as well as information defining a desired position of the overlay. The information defining the media elements forming the overlay may include the media elements themselves. Alternatively, the information defining the media elements may include references to the media elements, where the media elements may be stored by and subsequently obtained from the secondary device 14, local storage of the primary device 12, or a remote source. The information defining the desired position of the overlay may be information defining a desired position of the overlay as a whole such as, for example, at the top of the screen of the display device 18, at the bottom of the screen of the display device 18, or the like. Alternatively, the information defining the desired position of the overlay may define a desired position of each of the media elements forming the overlay. Still further, the overlay input may include timing information defining a time at which the overlay is to be presented. The timing information may define a time range during which the overlay is to be presented, indicate that the overlay is to be immediately presented and continue to be presented until otherwise instructed by the overlay control function 30, or the like.

The overlay control function 30 then enforces the overlay access rights to determine whether the overlay defined by the overlay input received from the overlay control function 30 of the secondary device 14 is permitted (step 106). If not, an error message may be returned to the overlay control function 30 of the secondary device 14. Note that, in an alternative embodiment, the user may be enabled to purchase a license to use the overlay as defined by the overlay input. If the overlay is permissible, in this embodiment, the overlay rights enforcement function 28 provides the media elements forming the overlay and the desired position of the overlay to the video playback function 26 of the primary device 12. Note that if the overlay input includes timing information, then the overlay rights enforcement function 28 may provide the overlay to the video playback function 26 at the appropriate time as defined by the timing information. In response, the video playback function 26 of the primary device 12 combines the overlay and the video content being played by the primary device 12 to provide combined content including the video content and the overlay that is then presented via the display device 18 (step 108).

Note that, in addition to or as an alternative to enforcing the overlay access rights after receiving the overlay input, after obtaining the overlay access rights, the overlay rights enforcement function 28 may expose one or more interfaces, such as web services interfaces, to the overlay control function 30 according to the overlay access rights. For example, if the overlay is not permitted at this time, the overlay rights enforcement function 28 may not expose one or more interfaces used to provide the overlay input to the primary device 12. In contrast, if the overlay is permitted in at least one position at this time, then the one or more interfaces used to provide the overlay input to the primary device 12 may be exposed.

In this example, the overlay rights enforcement function 28 continues to enforce the overlay access rights (step 110). More specifically, the access rights may vary depending on time or playback position. For example, the overlay access rights may be defined such that the overlay is permitted only at the bottom of the screen of the display device 18 from time₀ to time₁ and only at the top of the screen of the display device 18 from time₁ to time₂, where time₀ is a time at which the overlay is initially presented, time₁ is some defined time subsequent to time₀, and time₂ is some defined time subsequent to time₁. Time₀, time₁, and time₂ may be times of the day or playback positions in playback of the video content. Assuming that the overlay is initially positioned at the bottom of the screen of the display device 18 at time₀, the overlay access rights change at time₁. As such, the overlay may automatically be repositioned to a permitted position at time₁, which in this example is the top of the screen of the display device 18. Alternatively, an alert may be returned to the user 16 at the secondary device 14 prior to time₁ or at time₁ such that the user 16 can reposition the overlay if desired. If the user 16 does not reposition the overlay by time₁, then the overlay rights enforcement function 28 may remove the overlay from the video content being presented via the display device 18.

In this example, the overlay control function 30 of the secondary device 14 provides an overlay update to the primary device 12 (step 112). The overlay update may be in response to user input from the user 16 or an update of information contained in the overlay from a remote source of the information. More specifically, using a pointer overlay as an example, the overlay control function 30 may receive input from the user 16 for moving the pointer from a first location on the screen of the display device 18 to a second location. In response, the overlay control function 30 provides the overlay update including the updated position of the pointer overlay to the primary device 12. As for updating information from a remote source, the overlay may include live information such as, for example, scores of sporting events, news, stock prices, or the like. As such, the overlay control function 30 may obtain updates to the information from one or more remote sources by querying the one or more remote sources or by receiving automatic updates to the information pushed to the secondary device 14 from the one or more remote sources. In response, the overlay control function 30 provides the overlay update including the updated information for the overlay to the primary device 12.

In response to receiving the overlay update, the overlay rights enforcement function 28 continues to enforce the overlay access rights (step 1 14). For example, if the overlay update changes the position of the overlay, the overlay rights enforcement function 28 determines whether the updated location of the overlay is permissible based on the overlay access rights. If the updated overlay is not permissible, an error message may be returned to the secondary device 14. If the updated overlay is permissible, the overlay is updated by the primary device 12 (step 116).

Optionally, the overlay may include interactive media elements. As such, the overlay control function 30 may receive user input from the user 16 initiating a desired action enabled by the overlay (step 118). For example, the overlay may be a shopping overlay enabling the user 16 to select objects appearing in the video content to be directed to one or more e-commerce services enabling the user 16 to purchase the selected object, directed to an e-commerce service having a best deal on the selected object, or the like. As such, the user input may select a desired object appearing in the video content that the user 16 has an interest in purchasing. In response to receiving the input from the user 16, the overlay control function 30 effects the desired action (step 120). Returning to the shopping overlay example, upon receiving user input from the user 16 selecting an object, the overlay control function 30 directs the user 16 to one or more e-commerce services from which the selected object may be purchased. For example, if the selected object is a Movado® watch, the overlay control function 30 may direct the user 16 to one or more websites from which that Movado® watch may be purchased via a web browser of the secondary device 14.

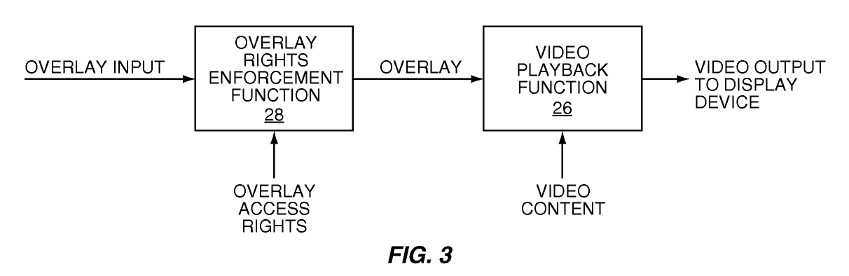

FIG. 3 illustrates the operation of the video playback function 26 and the overlay rights enforcement function 28 of the primary device 12 of FIG. 1 according to one embodiment of the present invention. In this embodiment, both the overlay and the video content are presented via a single display device 18. First, the overlay rights enforcement function 28 receives overlay input from the overlay control function 30 of the secondary device 14 and obtains corresponding overlay access rights. Based on the overlay access rights, the overlay rights enforcement function 28 determines whether the overlay defined by the overlay input received from the overlay control function 30 of the secondary device 14 is permitted. If so, the media elements forming the overlay and the information defining the position of the overlay are provided to the video playback function 26. In response, the video playback function 26 inserts the overlay into video content being played by the video playback function 26 to provide a video output including the video content and the overlay. The video output is provided to the display device 18 for presentation to the user 16.

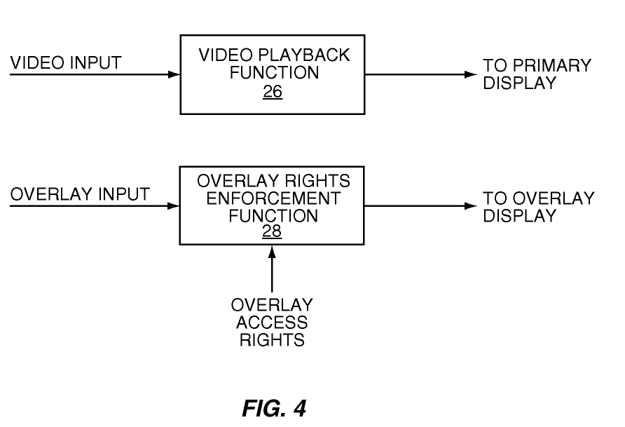

FIG. 4 illustrates the operation of the video playback function 26 and the overlay rights enforcement function 28 of the primary device 12 of FIG. 1 according to another embodiment of the present invention. In this embodiment, the video content is presented via a primary display device 18, and the overlay is presented via a secondary display device 18 positioned on top of or in front of the primary display 18. First, the video playback function 26 provides playback of video content and presents the video content to the user 16 via the primary display device 18. The overlay rights enforcement function 28 receives overlay input from the overlay control function 30 of the secondary device 14 and obtains corresponding overlay access rights. Based on the overlay access rights, the overlay rights enforcement function 28 determines whether the overlay defined by the overlay input received from the overlay control function 30 of the secondary device 14 is permitted. If so, overlay rights enforcement function 28 presents the overlay to the user 16 via the secondary display device 18 positioned on top of the primary display device 18 such that the media elements forming the overlay are overlaid on top of the video content being presented to the user 16 via the primary display 18.

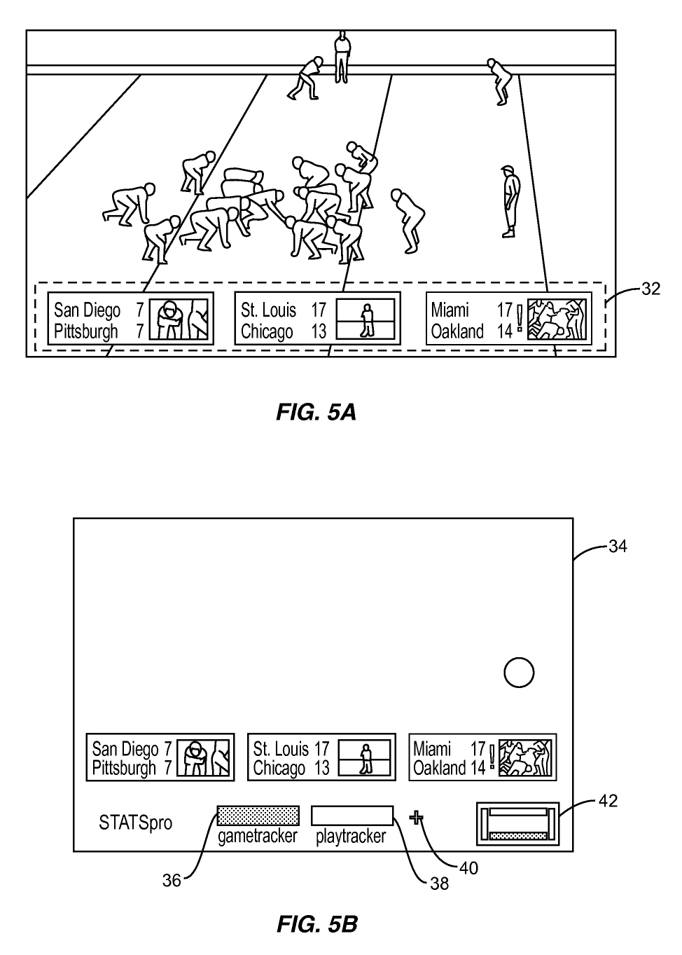

FIGS. 5A through 5C illustrate an exemplary overlay provided according to one embodiment of the present invention. FIG. 5A illustrates the output video content of the primary device 12 after insertion of a STATSpro overlay 32 provided by the overlay control function 30 of the secondary device 14. As illustrated, the STATSpro overlay 32 is positioned at the bottom of the screen and includes scores for a number of sporting events selected by the user 16. In addition, for each sporting event, the STATSpro overlay 32 includes a key frame. In one embodiment, both the scores of the sporting events and the key frames are updated by the overlay control function 30 of the secondary device 14. Still further, in this embodiment, the STATSpro overlay 32 enables a notification when, for example, the sporting event has reached a user-defined or system-defined critical point. The critical point may be, for example, a point during the game where the difference in the scores of the teams is near a predefined point spread for the sporting event. However, the present invention is not limited thereto. In this example, a notification in the form of an exclamation point is presented in association with the score of the Miami and Oakland football game included in the STATSpro overlay 32. As a result, the user 16 is notified that the sporting event has reached a critical point.

FIG. 5B illustrates an exemplary Graphical User Interface (GUI) 34 presented to the user 16 at the secondary device 14 to enable the user 16 to configure and control the STATSpro overlay 32 shown in FIG. 5A. The GUI 34 enables the user 16 to place the STATSpro overlay 32 in either a gametracker mode by selection of a corresponding button 36 or a playtracker mode by selecting a corresponding button 38. In this example, the STATSpro overlay 32 is in the gametracker mode such that the scores of a number of sporting events selected by the user 16 are presented via the STATSpro overlay 32 as shown in FIG. 5A. The user 16 may select button 40 to add the score of an additional sporting event to the STATSpro overlay 32. The GUI 34 also includes overlay position control buttons 42, which enable the user 16 to select the desired position of the STATSpro overlay 32. In this example, the user 16 has selected the bottom of the screen as the desired position of the STATSpro overlay 32.

FIG. 5C illustrates a scenario where the STATSpro overlay 32 is automatically repositioned in response to a change in the overlay access rights. As illustrated, at some point during playback, information is placed at the bottom of the screen by the content producer or content provider and, as a result, the overlay access rights are defined such that the STATSpro overlay 32 is no longer permitted at the bottom of the screen. In response to the change in the access rights, the STATSpro overlay 32 is automatically repositioned to a permitted position, which in this example is the top of the screen. In an alternative embodiment, an alert may be provided to the user 16 at the secondary device 14 such that the user 16 is enabled to reposition the STATSpro overlay 32. This type of alert would preferably be provided in advance of the change in the overlay access rights such that the user 16 is enabled to select a new position for the STATSpro overlay 32 before the overlay access rights change.

Note that, in one embodiment, the primary device 12 is a set-top box, and the user 16 may initiate a channel change to a television channel broadcasting one of the sporting events in the STATSpro overlay 32 by selecting the corresponding media element on the GUI 34 at the secondary device 14. In response, the overlay control function 30 of the secondary device 14 effects the channel change. For example, in one embodiment, the overlay control function 30 has access to a remote service hosting television schedules. The overlay control function 30 may query this remote service to determine the channel on which the selected sporting event is being broadcast. The overlay control function 30 may then cause the primary device 12 to switch to the channel on which the selected sporting event is being broadcast. Alternatively, the primary device 12 may store an Electronic Programming Guide (EPG) or the like. The overlay control function 30 may then provide information identifying the selected sporting event, such as the teams playing in the sporting event, to the primary device 12. The primary device 12 may then search the EPG for the selected sporting event and then switch to the corresponding television channel.

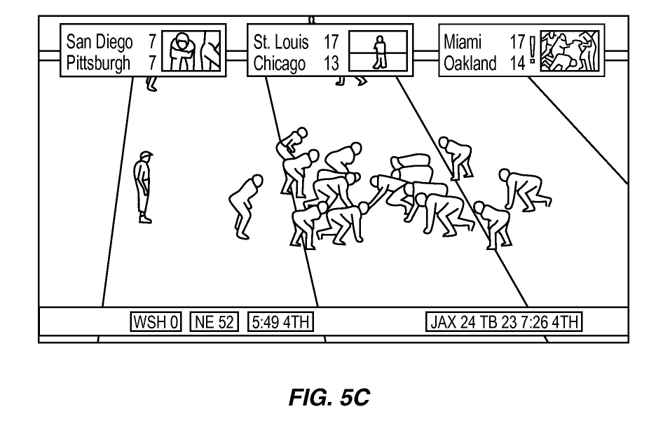

FIGS. 6A and 6B illustrate a telestrator overlay according to another exemplary embodiment of the present invention. FIG. 6A illustrates the video content including the telestrator overlay. FIG. 6B illustrates a GUI 44 presented to the user 16 by the overlay control function 30 at the secondary device 14 that enables the user 16 to configure and control the telestrator overlay.

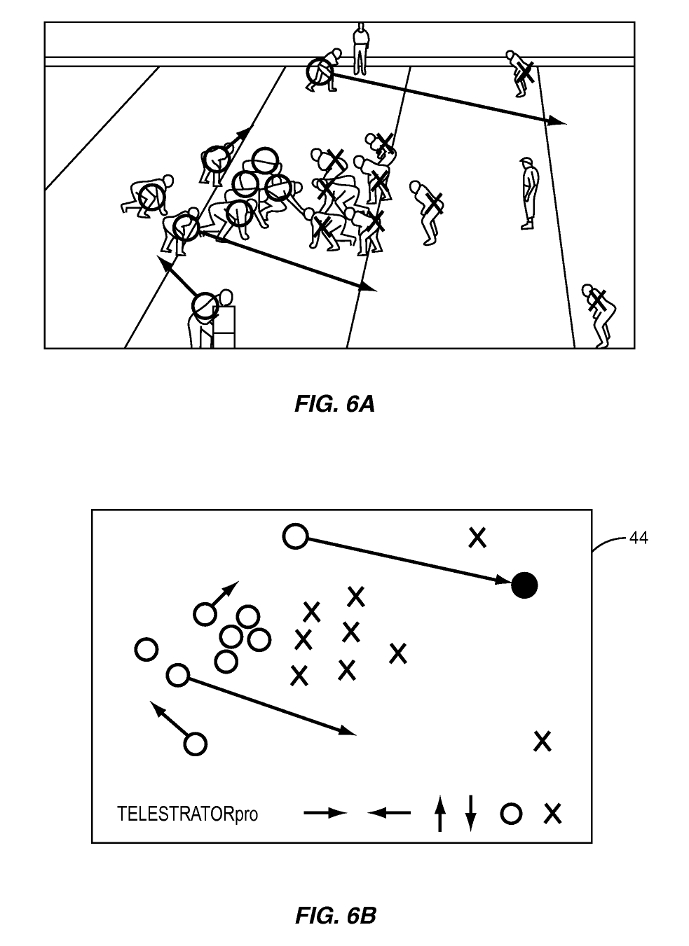

FIG. 7 is a block diagram of the primary device 12 of FIG. 1 according to one embodiment of the present invention. As illustrated, the primary device 12 includes a control system 46 having associated memory 48. In this example, the video playback function 26 and the overlay rights enforcement function 28 are implemented in software and stored in the memory 48. However, the present invention is not limited thereto. Each of the video playback function 26 and the overlay rights enforcement function 28 may be implemented in software, hardware, or a combination thereof. In addition, the primary device 12 includes one or more communication interfaces 50 communicatively coupling the primary device 12 to the secondary device 14 and, optionally, the network 22 (FIG. 1). In addition, the communication interfaces 50 may include one or more audio/video interfaces connecting the primary device 12 to the one or more display devices 18. Lastly, the primary device 12 may include a user interface 52, which may include a display, one or more user input devices, or the like.

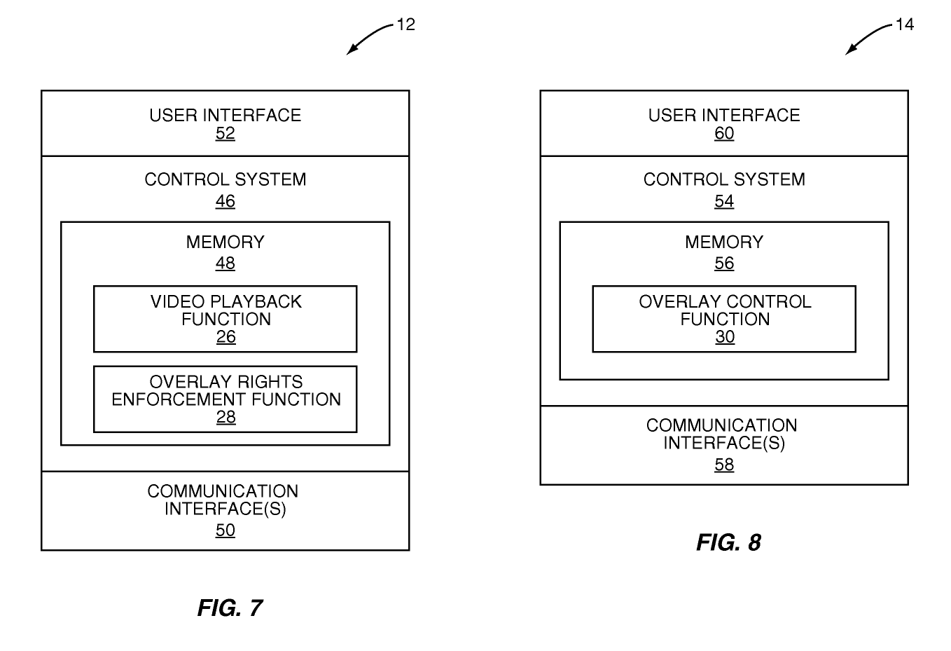

FIG. 8 is a block diagram of the secondary device 14 of FIG. 1 according to one embodiment of the present invention. As illustrated, the secondary device 14 includes a control system 54 having associated memory 56. In this example, the overlay control function 30 is implemented in software and stored in the memory 56. However, the present invention is not limited thereto. The overlay control function 30 may be implemented in software, hardware, or a combination thereof. In addition, the secondary device 14 includes one or more communication interfaces 58 communicatively coupling the secondary device 14 to the primary device 12 and, optionally, the network 22 (FIG. 1). Lastly, the secondary device 14 includes a user interface 60, which may include a display, one or more user input devices, and the like.

The present invention provides substantial opportunity for variation without departing from the spirit or scope of the present invention. For example, while the discussion above focuses on enforcing the overlay access rights at the primary device 12, the present invention is not limited thereto. The overlay access rights may additionally or alternatively be enforced at the secondary device 14. For example, the overlay access rights may additionally or alternatively be enforced by the overlay control function 30. As another example, while the discussion herein focuses on overlays, the present invention is not limited thereto. Rather than presenting the media elements as an overlay, the media elements referred to above as forming the overlay may alternatively be presented in association with, or simultaneously with, the video content in one or more unused areas of screen of the display device 18. For example, if the display device 18 is a widescreen device and the video content is standard 4:3 video content, then the unused sidebars of the screen of the display device 18 may be utilized to present the media elements under the control of the secondary device 14.

Those skilled in the art will recognize improvements and modifications to the preferred embodiments of the present invention. All such improvements and modifications are considered within the scope of the concepts disclosed herein and the claims that follow.

What is claimed is:

1. A method of operation for a primary device, comprising:
providing playback of video content;
presenting the video content via an associated display device;
receiving, from a secondary device, an overlay input defining an overlay to be presented in association with the video content;
determining whether the overlay is permitted; and
if the overlay is permitted, presenting the overlay in association with the video content.

2. The method of claim 1 wherein determining whether the overlay is permitted comprises:
obtaining overlay access rights for the video content; and
determining whether the overlay is permitted based on the overlay access rights for the video content.

3. The method of claim 2 wherein the overlay access rights define at least one of a group consisting of: a time at which overlays are permitted and a time at which overlays are not permitted.

4. The method of claim 2 wherein the overlay access rights define at least one of a group consisting of: a position at which overlays are permitted and a position at which overlays are not permitted.

5. The method of claim 1 wherein determining whether the overlay is permitted comprises:
obtaining overlay access rights specific to an overlay control function of the secondary device providing the overlay; and
determining whether the overlay is permitted based on the overlay access rights.

6. The method of claim 5 wherein the overlay access rights define at least one of a group consisting of: a time at which the overlay provided by the overlay control function of the secondary device is permitted and a time at which the overlay provided by the overlay control function of the secondary device is not permitted.

7. The method of claim 5 wherein the overlay access rights define at least one of a group consisting of: a position at which the overlay provided by the overlay control function of the secondary device is permitted and a position at which the overlay provided by the overlay control function of the secondary device is not permitted.

8. The method of claim 5 wherein obtaining the overlay access rights specific to the overlay control function of the secondary device providing the overlay comprises obtaining a license for the overlay control function from a license server, the license defining the overlay access rights specific to the overlay control function of the secondary device.

9. The method of claim 1 wherein determining whether the overlay is permitted comprises:
determining whether an overlay control function of the secondary device providing the overlay is a registered overlay control function;
if the overlay control function is a registered overlay control function:
obtaining overlay access rights specific to the overlay control function of the secondary device providing the overlay; and
determining whether the overlay is permitted based on the overlay access rights specific to the overlay control function; and
if the overlay control function is not a registered overlay control function:
obtaining default overlay access rights; and
determining whether the overlay is permitted based on the default overlay access rights.

10. The method of claim 1 wherein determining whether the overlay is permitted comprises:
obtaining overlay access rights specific to an overlay control function of the secondary device providing the overlay;
obtaining global overlay access rights applicable to all overlay control functions including the overlay control function of the secondary device providing the overlay; and
determining whether the overlay is permitted based on the overlay access rights specific to the overlay control function of the secondary device and the global overlay access rights.

11. The method of claim 1 wherein the overlay input comprises information defining one or more media elements forming the overlay and information defining a desired position for the overlay.

12. The method of claim 11 wherein the information defining the one or more media elements comprises the one or more media elements.

13. The method of claim 11 wherein the overlay input further comprises timing information for the overlay.

14. The method of claim 1 wherein the overlay is configured and controlled by a user via the secondary device.

15. The method of claim 1 further comprising:
receiving, from the secondary device, an overlay update defining an update to the overlay;
determining whether the update to the overlay is permitted; and
if the update to the overlay is permitted, updating the overlay presented in association with the video content.

16. The method of claim 15 wherein the overlay update is in response to user input at the secondary device.

17. The method of claim 15 wherein the overlay update comprises updated information for the overlay obtained by the secondary device from one or more remote sources.

18. The method of claim 1 wherein the overlay enables a user of the secondary device to initiate a desired action.

19. The method of claim 1 wherein receiving the overlay input from the secondary device comprises receiving the overlay input from the secondary device via a local connection.

20. The method of claim 19 wherein the secondary device is a mobile device, and the local connection is a local wireless connection.

21. The method of claim 1 wherein presenting the overlay in association with the video content comprises:
combining the overlay and the video content to provide combined content; and
presenting the combined content via the associated display device.

22. The method of claim 1 wherein presenting the overlay in association with the video content comprises presenting the overlay via a second associated display device positioned with respect to the associated display device such that the overlay is presented on top of the video content.

23. The method of claim 1 further comprising, prior to receiving the overlay input:
receiving, from the secondary device, an overlay initiation request;
obtaining overlay access rights in response to the overlay initiation request; and
exposing one or more interfaces to the secondary device according to the overlay access rights;
wherein receiving the overlay input comprises receiving the overlay input via the one or more interfaces exposed to the secondary device.

24. A computer readable medium comprising software for instructing a primary device to:
receive, from a secondary device, an overlay input defining an overlay to be presented in association with video content presented by the primary device via an associated display device;
determine whether the overlay is permitted; and
if the overlay is permitted, present the overlay in association with video content presented via the associated display device.

25. The computer readable medium of claim 24 wherein, in order to determine whether the overlay is permitted, the software instructs the primary device to:
obtain overlay access rights for the video content; and
determine whether the overlay is permitted based on the overlay access rights for the video content.

26. The computer readable medium of claim 25 wherein the overlay access rights define at least one of a group consisting of: a time at which overlays are permitted and a time at which overlays are not permitted.

27. The computer readable medium of claim 25 wherein the overlay access rights define at least one of a group consisting of: a position at which overlays are permitted and a position at which overlays are not permitted.

28. The computer readable medium of claim 24 wherein, in order to determine whether the overlay is permitted, the software instructs the primary device to:
obtain overlay access rights specific to an overlay control function of the secondary device providing the overlay; and
determine whether the overlay is permitted based on the overlay access rights.

29. The computer readable medium of claim 28 wherein the overlay access rights define at least one of a group consisting of: a time at which the overlay provided by the overlay control function of the secondary device is permitted and a time at which the overlay provided by the overlay control function of the secondary device is not permitted.

30. The computer readable medium of claim 28 wherein the overlay access rights define at least one of a group consisting of: a position at which the overlay provided by the overlay control function of the secondary device is permitted and a position at which the overlay provided by the overlay control function of the secondary device is not permitted.

31. The computer readable medium of claim 28 wherein, in order to obtain the overlay access rights specific to the overlay control function of the secondary device providing the overlay, the software instructs the primary device to obtain a license for the overlay control function from a license server, the license defining the overlay access rights specific to the overlay control function of the secondary device.

32. A system comprising:
a local communication interface; and
a control system associated with the local communication interface and adapted to:
provide playback of video content;
present the video content via an associated display device;
receive, from a secondary device, an overlay input defining an overlay to be presented in association with the video content;
determine whether the overlay is permitted; and
if the overlay is permitted, present the overlay in association with the video content.

33. The system of claim 32 wherein, in order to determine whether the overlay is permitted, the control system is further adapted to:
obtain overlay access rights for the video content; and
determine whether the overlay is permitted based on the overlay access rights for the video content.

34. The system of claim 33 wherein the overlay access rights define at least one of a group consisting of: a time at which overlays are permitted and a time at which overlays are not permitted.

35. The system of claim 33 wherein the overlay access rights define at least one of a group consisting of: a position at which overlays are permitted and a position at which overlays are not permitted.

36. The system of claim 32 wherein, in order to determine whether the overlay is permitted, the control system is further adapted to:
obtain overlay access rights specific to an overlay control function of the secondary device providing the overlay; and
determine whether the overlay is permitted based on the overlay access rights.

37. The system of claim 36 wherein the overlay access rights define at least one of a group consisting of: a time at which the overlay provided by the overlay control function of the secondary device is permitted and a time at which the overlay provided by the overlay control function of the secondary device is not permitted.

38. The system of claim 36 wherein the overlay access rights define at least one of a group consisting of: a position at which the overlay provided by the overlay control function of the secondary device is permitted and a position at which the overlay provided by the overlay control function of the secondary device is not permitted.

39. The system of claim 36 wherein, in order to obtain the overlay access rights specific to the overlay control function of the secondary device providing the overlay, the control system is further adapted to obtain a license for the overlay control function from a license server, the license defining the overlay access rights specific to the overlay control function of the secondary device.
